(19) United States
(12) Patent Application Publication
(10) Pub. No.: US 2015/0367445 A1
(43) Pub. Date: Dec. 24, 2015

(54) DEPOSITION WELDING WITH PRIOR REMELTING

(71) Applicant: SIEMENS AKTIENGESELLSCHAFT, München (DE)

(72) Inventors: Bernd BURBAUM, Falkensee (DE); Torsten JOKISCH, Neuenhagen bei Berlin (DE); Michael OTT, Mülheim an der Ruhr (DE); Sebastian PIEGERT, Lübbenau (DE)

(21) Appl. No.: 14/761,034

(22) PCT Filed: Jan. 9, 2014
(86) PCT No.: PCT/EP2014/050295

§ 371 Date: Jul. 15, 2015

(30) Foreign Application Priority Data
Jan. 18, 2013 (EP) 13151888.8

(51) Int. Cl. B23K 26/342; C22C 19/05; C22C 19/07

(52) U.S. Cl. CPC B23K 26/342; C22C 19/07; C22C 19/057; C22C 19/056; C22C 19/055

(57) ABSTRACT

A substrate (4) is remelted prior to deposition welding, thereby substantially reducing stresses in the region of the interface between the deposition welded portion (13) and the substrate (4).

### CROSS-REFERENCE TO RELATED APPLICATIONS

The present application is a 35 U.S.C. §§ 371 national phase conversion of PCT/EP2014/050295, filed Jan. 9, 2014, which claims priority of European Application No. 13151888.8, filed Jan. 18, 2013, the contents of which are incorporated by reference herein. The PCT International Application was published in the German language.

The invention relates to a deposition welding method, in which an at least partial remelting is carried out beforehand in the region of that surface on which the material is deposited.

### TECHNICAL BACKGROUND

Remelting methods for closing cracks and deposition welding methods in order to compensate for a loss of material or to build up structure on a surface are known from the prior art. Also known is the use of a laser in the context of these methods.

It is also known from the prior art to remelt column-solidified substrates or single-crystal substrates, wherein the latter occur in nickel-based superalloys of turbine blades. However, the edge region of the weld often experiences increased stresses between the substrate and the deposited region.

The invention therefore has the object of solving the above-mentioned problem.

Advantageous measures, which may be combined with one another in any desired manner in order to achieve further advantages, are disclosed.

### BRIEF DESCRIPTION OF THE DRAWINGS

In the figures:

FIG. 1 shows a substrate,

FIG. 2 shows a substrate with a remelted region,

FIG. 3 shows a substrate according to FIG. 2 with a deposition weld,

FIGS. 4-7 show exemplary embodiments for the remelted region,

FIG. 8 is a list of superalloys.

### DESCRIPTION OF EMBODIMENTS

The figures and the description represent exemplary embodiments of the invention.

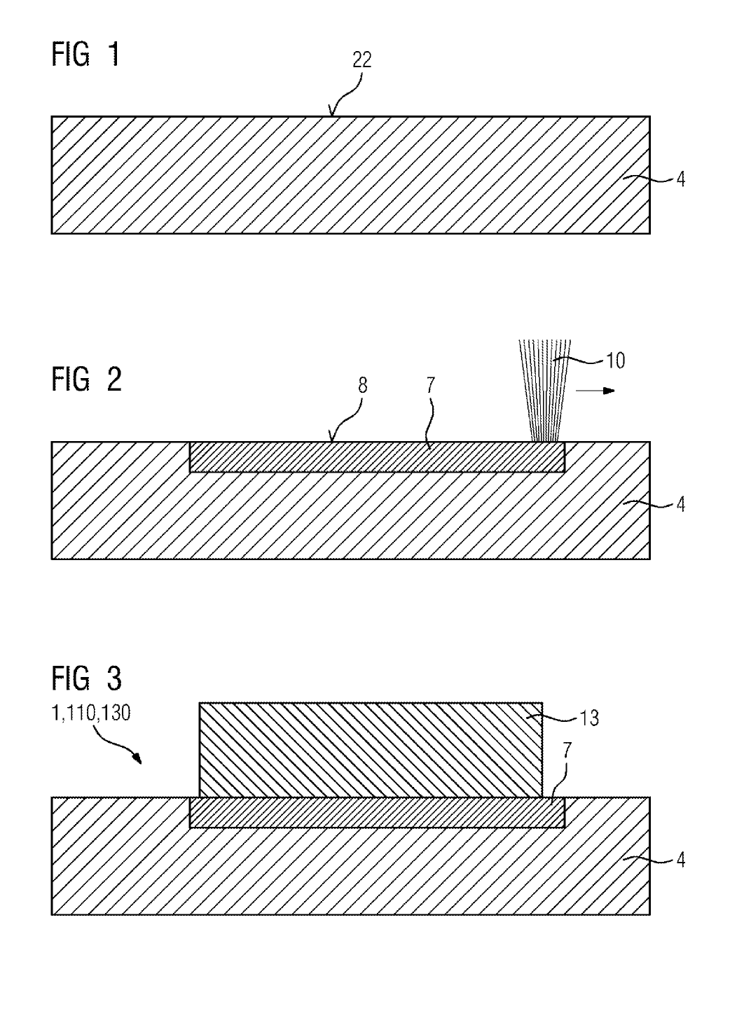

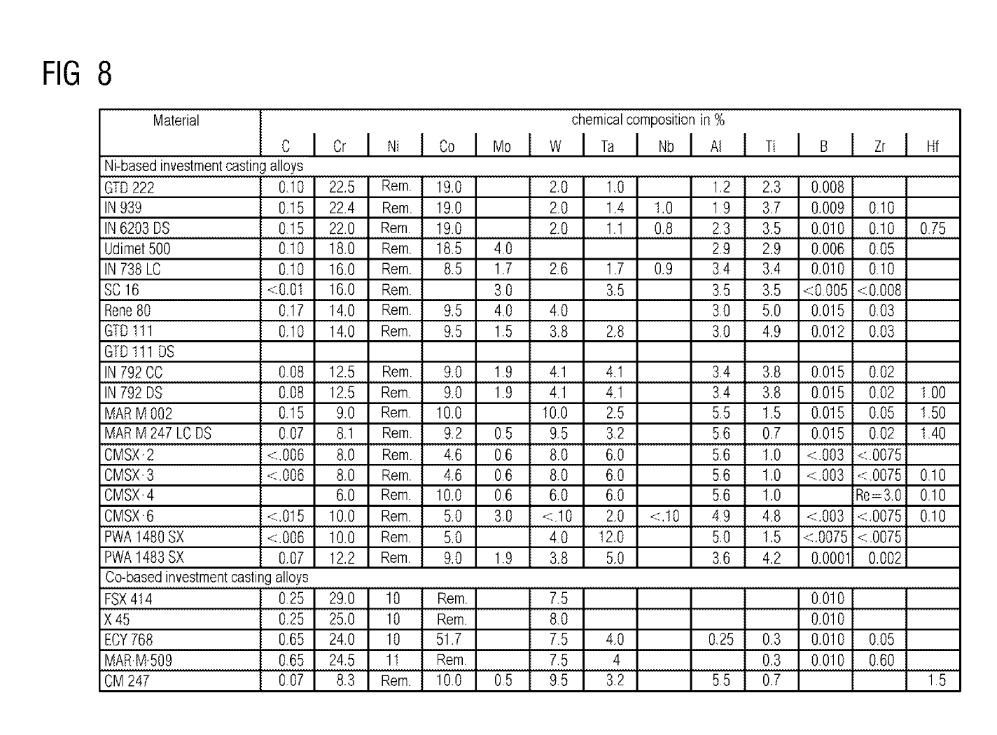

FIG. 1 shows a known substrate 4 which is to be worked. The substrate 4 is preferably metallic and very preferably includes a cobalt-based or nickel-based superalloy, such as is in particular listed in FIG. 8.

The substrate 4 can have a single-crystal, column-solidified or polycrystalline structure.

A columnar structure has grain boundaries which are often encompassed by a deposition weld.

A material 13 (FIG. 3) is to be applied to a surface region 8 (FIG. 2) of the surface 22 by means of deposition welding.

In order to prepare this deposition weld, a remelt method is carried out beforehand in at least part of the surface region 8 which is to be welded.

This remelt is effected by means of a high-energy beam, such as a welding beam 10 (FIG. 2), in particular a laser beam 10, which generates a remelt region 7 within and to a selected depth in the substrate 4, and generates small grains.

In this remelt process, no material is applied. This remelt process is preferably carried out in its entirety prior to the deposition welding.

After the remelting has been carried out, a deposition weld 13 is applied over the remelted region 7, as shown in FIG. 3.

This can be effected in a great many ways, in particular by means of a laser deposition welding process.

The remelt region 7 on which the deposition welding 13 is carried out can be remelted entirely and preferably in an exactly-fitting manner (FIG. 7), and preferably somewhat beyond the region 7 (FIG. 3).

It is however also possible to carry out the remelting only at certain points within the surface region 8 in which the deposition weld 13 is to be generated.

This is the case e.g. in column-solidified grains, for example in FIG. 5, in which a clear number of grain boundaries 19′, 19″ are present in the surface region 8 to be deposition welded, and wherein the remelt method is carried out preferably only along the grain boundaries 19′, 19″. Thus, a remelt region 7′, 7″ preferably encloses only grain boundaries 19′, 19″.

One or more grain boundaries can be present in the surface region 8 to be deposition welded.

As shown in FIG. 6, it is also possible to remelt only along the outer contour 22 of the surface region 8 of the remelt region 7, 7′, such that here a border of the surface region 8 of the deposition weld represents the remelt region 7, 7′.

The procedures of FIG. 5 and FIG. 6 can also be combined .

Polycrystalline or directionally solidified substrates 4 can be remelted in polycrystalline and, where relevant, in a directionally solidified fashion.

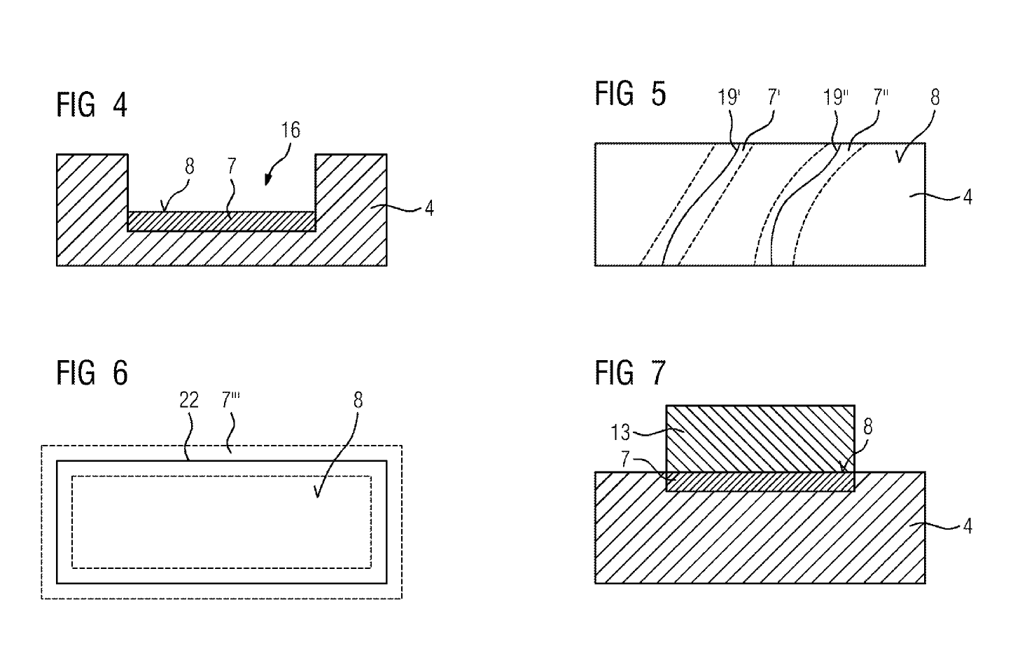

Equally, the method can be used if a pool crater 16 or a depression 16 has to be filled. In that case, the bottom of the pool crater 16 is then remelted (FIG. 4)

forming a remelted region 7′. Equally, in the pool crater 16, it is possible for only grain boundaries 19′, 19″ to be remelted as shown in FIG. 5.

The surface region 8 preferably includes no cracks prior to remelting.

Should cracks be present, they are preferably additionally closed separately beforehand, and in particular, preferably remelted and filled, before the method according to the invention is carried out.

The surface region 8 which is remelted, including also with cracks which have or have not been closed, is larger than the surface of a remelted crack, i.e. at least 200% larger.

The deposition welding 13 stands above the surface 22, and in particular markedly so. It therefore does not serve to even out a pool crater with respect to the surface 22. In FIG. 2, the surface 22 represents the bottom of the depression 16.

By virtue of the procedure as shown in FIGS. 3 to 7, stresses in the transition between the deposition weld 13 and the surface 22, in particular in the transition region in the region of the edges, are markedly reduced.

1. A method for deposition welding on a substrate having a surface region beneath a surface of the substrate;
the method comprising:
at least at selected points in the surface region beneath the surface of the substrate at which a deposition weld is to be generated,
generating a remelt region in the substrate; and then performing
a deposition weld on the remelt region wherein the remelt region comprises the entire surface region on which the deposition weld is generated.

2. (canceled)

3. A method for deposition welding on a substrate having a surface region beneath a surface of the substrate;
the method comprising:
at least at selected points in the surface region beneath the surface of the substrate at which a deposition weld is to be generated, generating a remelt region in the substrate; and then performing a deposition weld on the remelt region wherein the remelt region comprises an outer contour of the surface region on which the deposition weld is generated.

4. The method as claimed in claim 1, wherein the remelt region is larger in area than a base area of the deposition weld and the remelt region entirely comprises the deposition weld.

5. The method as claimed in claim 1, wherein the remelt region comprises grain boundaries of a column-solidified structure or small-angle grain boundaries of a single-crystal structure.

6. The method as claimed in claim 1, further comprising remelting the surface in which the deposition weld is generated only at selected points over the surface.

7. The method as claimed in claim 1, further comprising applying the deposition weld within a pool crater in the surface.

8. The method as claimed in claim 1 wherein the substrate has a directionally solidified structure.

9. The method as claimed in claim 1, wherein the substrate is polycrystalline.

10. The method as claimed in further comprising directionally solidifying the remelt region.

11. The method as claimed in claim 1, further comprising solidifying the remelt region in a polycrystalline manner.

12. The method as claimed in claim 1, comprising using a laser deposition welding process

13. (canceled)

14. The method as claimed in claim 1, further comprising performing the deposition weld only after the remelt region has been completely generated.

15. The method as claimed in claim 1, wherein the surface region which is remelted has no cracks.

16. The method as claimed in claim 1, wherein the surface region which is remelted has an area that is at least 200% greater than a region of a remelted crack or a machined region of a crack or of cracks.

17. A component produced by the method as claimed in claim 1, comprising, at least in part, a remelt region on which a deposition weld is present.

18. The component as claimed in claim 17, wherein the remelt region at least entirely comprises the area of the deposition weld.

19. The component as claimed in claim 17, wherein the remelt region only partially comprises the area on which the deposition weld is present.

20. The component as claimed in claim 17, wherein the substrate has a directionally solidified structure.

21. The component as claimed in claim 20, wherein the directionally solidified structure includes a polycrystalline substrate.

22. The component as claimed in claim 17, wherein the remelt region is directionally solidified.

23. The component as claimed in claim 17, wherein the remelt region is polycrystalline.

24. The component as claimed in claim 17, wherein the deposition weld stands upward from the surface.

25. The component as claimed in claim 17, wherein the surface region which is remelted has an area that is at least 200% greater than a remelted crack or a machined region of a crack or of cracks.

26. The method as claimed in claim 1, further comprising using a laser for the remelting.

27. The method as claimed in claim 2, wherein the remelt region comprises only the entire surface region.

28. The method as claimed in claim 4, wherein the region comprises only grain boundaries of a column-solidified structure or small-angle grain boundaries of a single-crystal structure.

29. The method as claimed in claim 8, wherein the substrate has a column-solidified structure.

30. The method as claimed in claim 8, wherein the substrate has a single-crystal structure.

31. The component as claimed in claim 20, has a column-solidified structure,

32. The component as claimed in claim 20, has a single-crystal structure.
